(19) United States
(12) Patent Application Publication
(10) Pub. No.: US 2003/0112091 A1
(43) Pub. Date: Jun. 19, 2003

(54) High speed, controlled impedance air dielectric circuit modules for electronic backplane systems

(76) Inventors: Timothy A. Lemke, Dillsburg, PA (US); Richard A. Elco, Mechanicsburg, PA (US)

Correspondence Address: Roberts Abokhair & Mardula, LLC, Suite 1000, 11800 Sunrise Valley Drive, Reston, VA, 20191, US

(21) Appl. No.: 10/273,410

(22) Filed: Oct. 17, 2002

Related U.S. Application Data
(60) Provisional application No. 60/348,196, filed on Oct. 19, 2001.

(51) Int. Cl. H01P 5/02

(52) U.S. Cl. 333/33; 333/1

(57) ABSTRACT

A novel backplane interconnection system that is useful in the telecommunication and data process industries for ultra high speed backplane systems. It is capable of transmitting digital signals with bandwidths of 10 GHz and beyond. The invention provides high performance at a low cost of manufacture. It is suitable for use in a wide variety of system applications.

One embodiment of the invention comprises an air dielectric and copper conductor matched impedance transmission line system that interconnects daughter cards in a conventional backplane configuration. The high speed transmission-line structure is continuous through the backplane-daughter card and return path. Such embodiment are also integrated with conventional printed circuit backplanes or be a stand-alone device.

### CROSS REFERENCE TO RELATED APPLICATIONS

This application claims priority under 35 USC 119 to U.S. provisional patent serial No. 60/348,196, filed Oct. 19, 2001.

### BACKGROUND OF THE INVENTION

The dominant theme in the development of electronics hardware for both the computer and telecommunications markets is increased bandwidth. The demand for more system speed and bandwidth comes from two opposite ends of the data communications and telecommunications hierarchy: desired improvements in microprocessor hardware performance and the increasing demands for greater throughput in the global telecommunications network (in part driven by the explosive growth of the Internet.)

The need for increased system bandwidth for broadband data transmission rates in telecommunications and data communications backplane systems has led to several general technical solutions. A first solution has been to increase the density of moderate speed parallel bus structures. Another solution has focused on relatively less dense, high data rate differential pair channels.

These solutions have yielded still another solution—the all cable backplanes that are currently used in some data communications applications. Each of these solutions, however, suffers from bandwidth limitations imposed by conductor and printed circuit board (PCB) or cable dielectric losses.

The Shannon-Hartley Theorem provides that, for any given broadband data transmission system protocol, there is usually a linear relationship between the desired system data rate (in Gigabits/sec) and the required system 3 decibel (3 dB) bandwidth in Gigahertz (GHz). For example, using fiber channel protocol, the available data rate is approximately four times the 3 dB system bandwidth. It should be understood that bandwidth considerations related to attenuation are usually referenced to the so-called “3 dB bandwidth”.

With bandwidth requirements now escalating to 10 GHz and beyond, both standard printed circuit boards and their associated connectors have reached a performance barrier that will be difficult to breach by conventional means. For example, in a standard 19″ rack mounted system, the accepted value for the maximum practical bandwidth with typical connector configurations is about 2.5 GHz. The maximum theoretical channel bandwidth, using state of-the art material and connector designs, is about 6 GHz. Beyond about 5 GHz, fiber optics, cabling and alternative new technologies such as wave guides are possible, but costly, solutions.

Although there will be many technologies competing for this future market, only those that are both cost competitive and meet the technical requirements will succeed. In addition, it will be important that the solution will fit the existing infrastructure so that it can be implemented in a relatively short period of time.

Air dielectric transmission lines are useful in transmitting high frequency, high bandwidth signals across a printed circuit board. Dielectric losses of insulators used in printed circuit board constructions cause significant signal losses at high frequencies. Even specialized materials such as fluorocarbons can have relatively high losses in high frequency applications. This has been well known and has resulted in the development and the construction of air dielectric coaxial cables. Another source of loss in high speed circuit boards is resistive losses. Again conventional printed circuit boards use relatively thin foils that limit the potential bandwidth of the circuit boards. Increasing the width of the copper foils limits the circuit density or the width and pitch of the lines etched into the circuitry. Furthermore, since most of the loss effect is “skin-effect” related, increasing the width of the conductor has a greater effect on transmission losses than just increasing the thickness.

The attenuation of a broadside coupled PCB conductor pair data channel has two components, a square root of frequency term due to conductor losses and a linear term in frequency arising from dielectric losses as shown in FIG. 1. The pitch of the data channels is p, w is the trace width, “rho” is the resistivity of the PCB traces, and k and DF are respectively the permittivity and dissipation factor or loss tangent of the PCB dielectric. For scaling, w/p is held constant at ˜0.5 or less and Zo is held constant by making the layer spacing between traces, h, proportional to p where h/p=0.2. The solution of the equations of FIG. 1 for A=3 db yields the 3 db bandwidth of the data channel for a specific backplane length, L.

A typical high performance, low loss PCB material is Speedboard (TM), as available from W. L. Gore & Associates of Newark, Del. The bandwidth per channel for a 0.75 m Speedboard (TM) backplane is shown in FIG. 2. As the data channel pitch, p, decreases, the channel bandwidth decreases due to increasing conductor losses relative to the dielectric losses. For a highly parallel backplane, the bandwidth-density per channel layer, BW/p, is of primary concern in that as the density of the parallel channels increases, one hopes that the increase in the density occurs faster than the drop in the channel bandwidth and that the total system bandwidth increases. However, as is shown in the plot of bandwidth-density vs. channel pitch for the Speedboard (TM) backplane shown in FIG. 3, the bandwidth-density reaches a maximum at a channel pitch of approximately 1.2 mm. Any further decrease in the channel pitch actually results in a decrease in bandwidth-density and a decrease in system performance! This maximum in bandwidth-density occurs when the conductor and dielectric losses are approximately equal.

The backplane connector performance can be characterized in terms of the bandwidth vs. bandwidth-density plane, or “phase plane” representation. Plots of bandwidth vs. bandwidth-density/layer for a 0.5 m FR-4 backplane, and 1 m and 0.75 m Speedboard (TM) backplanes are shown in FIG. 4 where the channel pitch is the independent variable. It is clearly evident that, for a given bandwidth-density, there are two possible solutions for channel bandwidth, i.e., a dense low bandwidth “parallel” solution and a high bandwidth “serial” solution. The limits on bandwidth-density for even high performance PCB's are clear.

The bandwidth versus bandwidth density characteristics of a typical connector system, e.g., the Metral™ family of 4 row pin and socket, High Speed, HS™, and the High Bandwidth, HB™, connectors, available from Berg Technology, Mechanicsburg, Pa. are also shown in FIG. 4. How well the plot of each connector type overlaps that of a particular backplane system is an indication of how well the connector is “matched” to that backplane system.

Cabling, using low dielectric constant and loss tangent materials such as foamed fluorocarbons in transmission line or coaxial cable configurations are a potential alternative means for high speed transmission. However cables can be relatively high cost, and, in addition, most cable termination techniques can introduce significant signal discontinuities, which, at this speed, can have significant effects on bandwidth. Often, foamed cables with low dielectric constant are inherently unstable and dimensional control is difficult to achieve economically, particularly with miniaturized designs.

If conventional “copper” circuitry is to be used for the transmission of high speed signals, the effects of dielectric losses and conductor losses need to be overcome. One method of minimizing conductive losses is to use rectangular or round conductors assembled into a circuit. If conductive “wires” are used rather than etched foil the geometry can be designed to optimize the performance and circuit density. This particular discussion focuses on round conductors. Rectangular systems have there own unique set of advantages and disadvantages. One advantage of round conductors is that they are readily available and handled by conventional equipment and do not require high cost tooling to fabricate. However, in order to optimize the performance of larger cross-sectional area conductors—dielectric losses must be correspondingly minimized. The ideal case is the use of air dielectrics, which offers the best environment for wide bandwidth signal transmission. Air has a relative dielectric constant of 1 and a negligible loss tangent. The present invention solves these needs and provides, further, related advantages.

### BRIEF SUMMARY OF INVENTION

A novel backplane interconnection system that is useful in the telecommunication and data process industries for ultra high speed backplane systems. It is capable of transmitting digital signals with bandwidths of 10 GHz and beyond. The invention provides high performance at a low cost of manufacture. It is suitable for use in a wide variety of system applications .

The present invention provides systems and methods for constructing an interconnection system using transmission line elements having an air dielectric to achieve the transmission of high frequency, high bandwidth signals between two electrical systems. The air dielectric backplane interconnection system of the present invention is used to connect backplane connectors or circuit boards to other circuit boards, such as, for example, daughter boards or the like.

One embodiment of the invention comprises an air dielectric and copper conductor matched impedance transmission line system that interconnects daughter cards in a conventional backplane configuration. The high speed transmission-line structure is continuous through the backplane-daughter card and return path. Such embodiment are also integrated with conventional printed circuit backplanes or be a stand-alone device.

In another embodiment the invention is used as a stand-alone design.

The backplane connectors of the present invention are integrated into the backplane interconnection system transmission lines so that impedance mismatches are minimized throughout the signal path. In some preferred embodiments, the backplane interconnection system transmission line structure is attached to a conventional multi-layer printed circuit board. The backplane connector may be press-fitted on the opposing side of the board or otherwise attached. In this fashion the invention is integrated with conventional connectors and electronic circuit boards.

In another embodiment of the invention, transmission line modules are installed in a staggered or offset pattern, so that the signal enters one set of pins on the connector, traverses a matched impedance path to the daughter card and returns via the daughter card to another set of connector pins. This technique minimizes the effect of circuit “stubs” that limit high speed performance.

The differential pairs in the system are paired in a column-based, row based, or combination of column and row based orientation.

In one another embodiment of the present invention, a high speed backplane interconnection system comprises a plurality of conductor matched impedance transmission line elements and an air dielectric surrounding the plurality of transmission line elements. In another embodiment of the present invention, the system includes a ground plate disposed a predetermined distance from the transmission line elements. For example, spacers are used to dispose the transmission line elements a predetermined distance thereby creating a predetermined characteristic impedance of the interconnection system.

### BRIEF SUMMARY OF THE DRAWINGS

FIG. 1 illustrates calculations of attenuation For broadside coupled differential pairs in printed circuit boards;

FIG. 2 illustrates channel bandwidth versus data channel pitch;

FIG. 3 illustrates bandwidth density versus data channel pitch;

FIG. 4 illustrates bandwidth versus bandwidth density per layer for different printed circuit board materials;

FIG. 5A illustrates a plan view of one embodiment of a Backplane Interconnection System Module;

FIG. 5B illustrates a side view of one embodiment of a Backplane Interconnection System Module;

FIG. 5C illustrates a detailed side view of a spacer structure of one embodiment of a Backplane Interconnection System Module;

FIG. 5D illustrates a detailed side view of a monofilament spacer structure of one embodiment of a Backplane Interconnection System Module;

FIG. 5E illustrates a plan view and a side view of a ground plane of one embodiment of a Backplane Interconnection System Module;

FIG. 6 illustrates TDR of one embodiment of a Backplane Interconnection System Module;

FIG. 7 illustrates bandwidth versus bandwidth density of other backplane systems and one embodiment of a Backplane Interconnection System Module;

FIG. 8 identifies an example specification for a 40 mm Backplane Interconnection System Module of one embodiment of the invention;

FIG. 9A schematically illustrates embodiments of the present invention using lead frame communication link elements;

FIG. 9B schematically illustrates embodiments of the present invention using module supported communication link elements mounted to the front surface of the backplane;

FIG. 9C schematically illustrates embodiments of the present invention using module supported communication link elements mounted to the back surface of the backplane;

FIG. 10 illustrates routing of lines in Backplane Interconnection System;

FIG. 11 iillustrates Intercorinection of daughter cards with Backplane Interconnection System;

FIG. 12 illustrates routing of signal lines through daughter cards to Backplane Interconnection System;

FIG. 13 illustrates lead frames for a test board for one embodiment of the present invention;

FIG. 14 illustrates four slot test printed circuit board (PCB) for one embodiment of the present invention;

FIG. 15 illustrates test board circuit traces for Pattern FIG. 15 of slots 2 and 3 of a four slot test printed circuit board (PCB) for one embodiment of the present invention; and

FIG. 16 illustrates test board circuit traces for Pattern FIG. 16 of slots 1 and 4 of a four slot test printed circuit board (PCB) for one embodiment of the present invention.

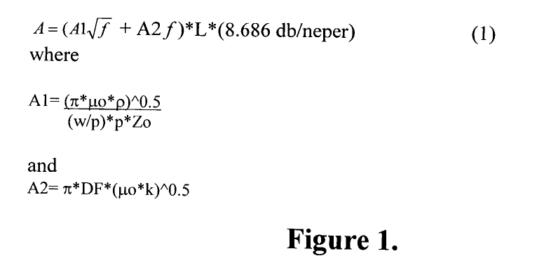

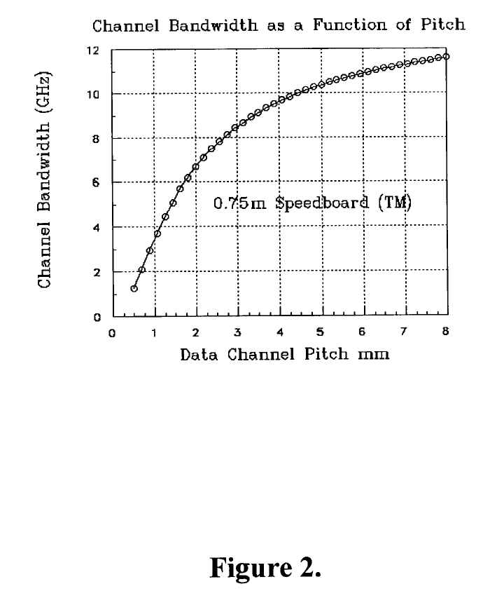

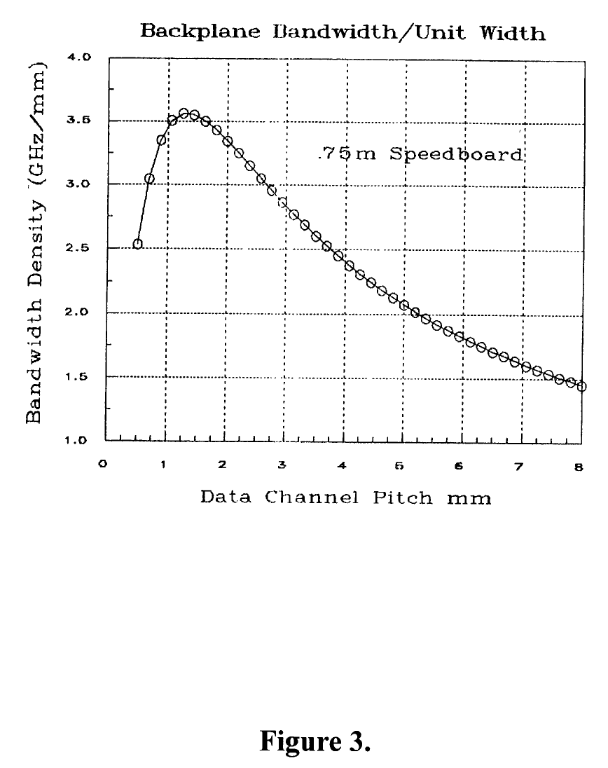

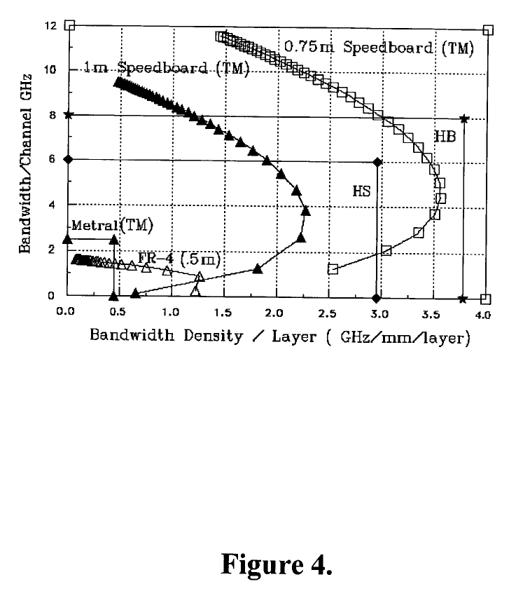

### DETAILED DESCRIPTION OF THE INVENTION

The present invention comprises a novel backplane interconnection system that is useful in the telecommunication and data process industries for ultra high speed backplane systems. It is capable of transmitting digital signals with bandwidths of 10 GHz and beyond. The invention provides high performance at a low cost of manufacture. It is suitable for use in a wide variety of system applications.

The present invention utilizes an air dielectric and copper conductor matched impedance transmission line system to achieve superior bandwidth performance. In certain embodiments daughter cards are interconnected in a conventional backplane configuration. The high speed transmission-line structure is continuous through the backplane-daughter card and return path. Such embodiment are also integrated with conventional printed circuit backplanes or be a stand-alone device.

A transmission line structure for high speed circuitry comprises two planes with a “wire” conductor, suspended in air, between the two planes or plates. The distance between the plates and the conductors is critical since this distance determines the characteristic impedance of the transmission line system. Typically, the impedance needs to be controlled to within 10% to prevent unwanted signal reflections.

At the scale required for printed circuit boards (PCB) it is necessary to control the space between the plates or planes and the conductor to several thousandths of an inch. This can be difficult to do since most conventional materials used for circuit boards are not very stable and subject to considerable warp and twist in their topography. If, for example, the conductors were to be perfectly straight and typical planes were to be suspended above and below them to form a transmission line structure, the surface variation will likely result in characteristic impedance variations greater than the required 10%.

One manufacturing problem is how the conductors are to be suspended between the plates themselves, without either disrupting the characteristic impedance of the transmission lines or causing significant dielectric losses. Although there are a number of ways in which this problem might be solved, the following is a simple, practical method of construction of an air-dielectric circuit board structure with tight tolerance control using more or less conventional materials and fabrication methods. Wire and filaments of almost any sort are typically manufactured by an extrusion process where the material is forced through a precisely formed die opening. The tolerances or wires and filaments are typically held to tenths of thousandths of an inch. This precision is easily sufficient for the tolerances required for the transmission lines. The use of these precisely extruded “wires” is particularly useful in embodiments of the backplane interconnection system transmission lines. One embodiment of constructing an air dielectric transmission line system in accordance with the resent invention is described below.

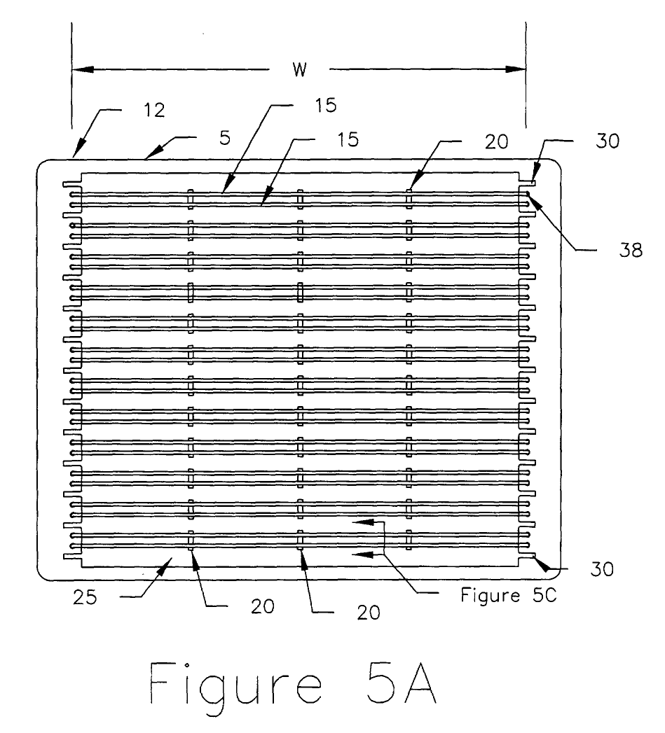

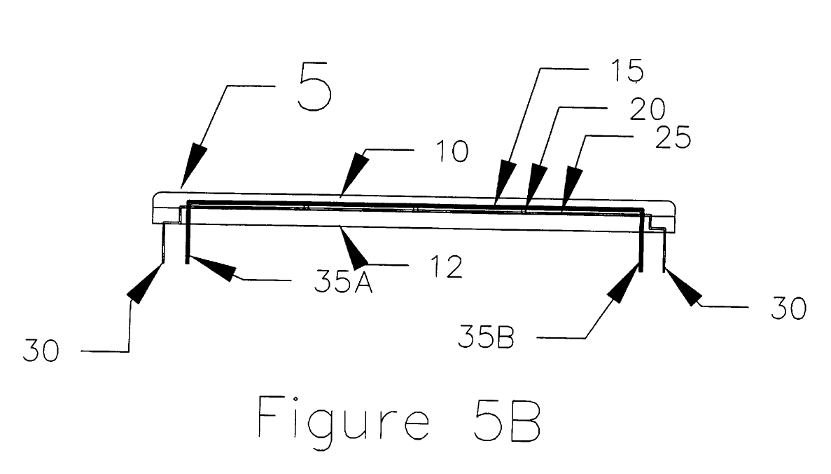

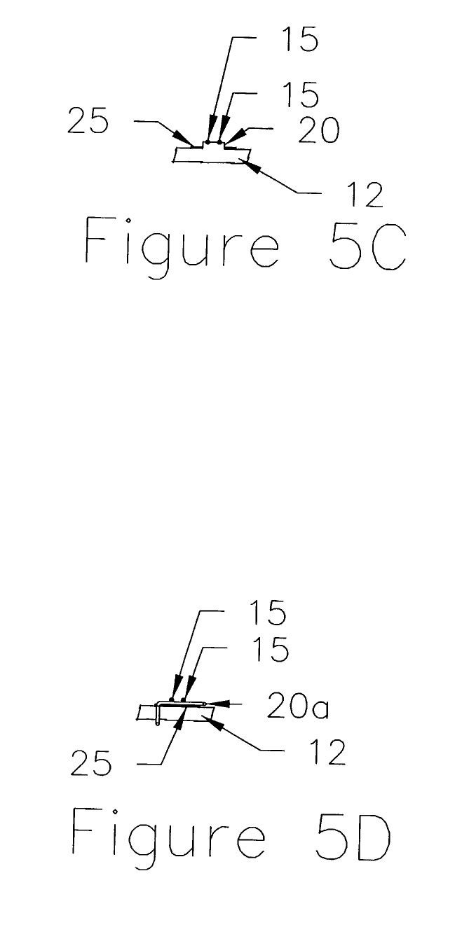

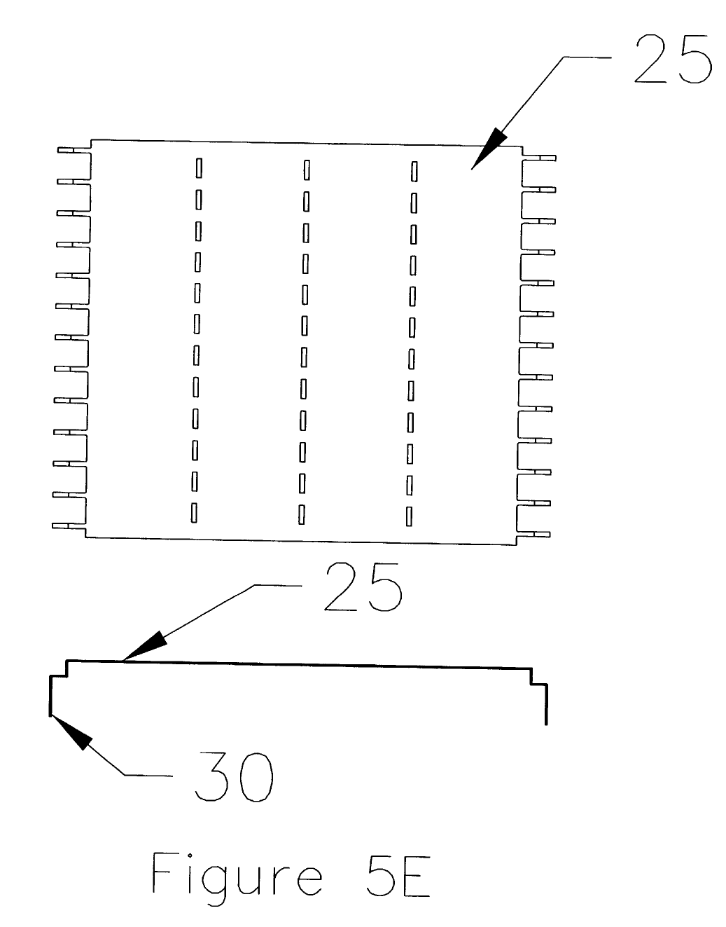

FIG. 5A and FIG. 5B are top and side views, respectively, of an interconnection system in accordance with one embodiment of the present invention. The high speed backplane interconnection system 5 includes two planes or plates 10, 12 with wire conductors or transmission lines 15 suspended there between. In a preferred embodiment, the two plates 10, 12 are formed from a non-conductive material. The transmission lines 15 are also connected to signal tabs 35A and 35B through apertures 38 in plate 12. Signal tabs 35A and 35B are then each connected to separate electrical systems (not shown) to electrically interconnect them via the transmission lines 15.

For example, the wire or filament conductors 15 may be manufactured using a conventional extrusion process, i.e. where the material is forced through a precisely formed die opening. The tolerances of extruded wires 15 are typically held to tenths of thousandths of an inch.

The system 5 also includes a ground plate 25 (shown in isolation in FIG. 5E) connected to ground tabs 30. The distance between the plate 25 and the conductors 15 determines the characteristic impedance of the transmission line system 5. Consequently, varying the distance between the ground plate 25 and the conductor 15 varies the characteristic impedance of the system.

In order to maintain a predetermined distance between the line elements and the plates, spacers 20 are disposed between the signal conductors 15 and the ground plate 25. FIG. 5C and FIG. 5D are a cross sectional view of the conductors and spacer elements as used in the interconnection system of the present invention in FIG. 5A. As shown in FIG. 5C, spacer 20 is formed to include grooves 21 for securing conductors 15 at a predetermined distance from the ground plate 25.

In FIG. 5D, the spacers are made of a polymer monofilament, however, other materials may be used without departing from the scope of the present invention. Typically the spacers or filaments are placed on a 0.250″ pitch and have a negligible effect on the characteristic impedance or the high speed transmission characteristics of the transmission line.

In one embodiment of the present invention, the spacers 20 are stitched into holes in the ground plate 25. Other configurations, such as gluing or molding the spacers to the ground plate 25 could be used without departing from the scope of the present invention.

In another embodiment of the present invention, external to the spacer matrix, larger conductors (not shown) are used to establish the overall structural spacing of the ground plates. For example, in the system described, a 22 AWG conductor (with a diameter of 0.025″) is placed on either side of a group of conductors to provide structural spacing for the system. The 22 AWG conductor may be bonded or soldered to the ground structures. This configuration is particularly useful in systems where power transmission is required throughout the backplane system. It is advantageous to have the power conductors closely coupled to the ground system, but electrically isolated to provide a capacitively coupled power system. Such a configuration may be integrated into the above described system by using a magnet wire, either round, square, or rectangular, of the appropriate dimensions to provide both a mechanical spacer for the transmission line system and a power distribution system.

In another embodiment of the present invention, the transmission line conductors are cut into discrete lengths and the ends bent at right angles to form staple like elements. The middle section of the staple would be determined by the link length and the short legs by the thickness of the PCB to which the link is to be mounted. The short legs of the “staple” would be inserted into holes in a thin PCB that would serve as the bottom shield of the link. The shield layer around the leads is etched away in the areas where the signal lines extend through the bard and the ground lines are soldered directly to the shield. The wire staples are then inserted over the spacers to provide the appropriate spacing for the impedance matched system. The upper shield layer would have additional filament spacers and would be assembled on top of the transmission line conductors. Furthermore, in this embodiment, the outer conductors of the link could consist of larger ground or capacitively coupled power conductors as previously discussed. The upper shield could be a thin printed circuit board similar to the bottom board, or could alternatively be a relatively thin sheet metal structure. The two shields are mechanically fastened to one another using a variety of fasteners. Some of the mechanical structures that might be used in the system design are extrusions with end caps, plastic molded frame, die cast frame, or screws or rivets with spacers.

In another embodiment, the links are surface mountable. In this manner, the tabs or solder tails 35A and 35B are bent such that they extend in the same plane as the link after insertion through the printed circuit board. Alternatively, the leads could extend in a co-planar manner through spacers and would be formed so that they would be co-planar to the link but be able to contact the printed circuit board surface.

In another embodiment of the present invention, alternative to the printed circuit base structure, a relatively thin sheet metal stamping is used having holes or slots stamped in the area where the leads are to protrude. A plastic molding with holes corresponding to the centers of the transmission line conductors is then press-fit through the holes in the stamping. In addition, the spacers may be part of the molding, eliminating the need for separate parts and assembly operations. Such spacers also include grooves to secure the conductors and the top cover is assembled to the base. The cover is designed to precisely clamp the conductors in place.

The clamping areas and transitions through the system are carefully designed to have controlled impedance throughout the structure and in the printed circuit board transition. In this manner, the printed circuit transition is carefully designed and the impedance is controlled by careful spacing of the centerlines of the ground and signal conductors through the system and in the printed circuit transition.

In another embodiment, the ground conductors are eliminated and the grounds are terminated by extensions of the ground planes by means of thin metal tabs 30 (FIG. 5A) that project through the housing and are soldered into holes or pads on the printed circuit board. Again, this can cause a slight reduction in the transmission line performance that is offset by the significant cost reduction that can be a result of eliminating about ⅓ of the conductors that are normally used.

In another embodiment of the present invention, the transmission lines are continuous over the length of the backplane. In this regard, the spacers are again molded to include slots to accept the conductors on the required pitch and are placed on the transmission line conductors at the same spacing as required by the connectors, generally 20 to 50 mm, with 40 mm and 50 mm being typical. These spacers may be molded separately and assembled to the transmission line conductors, or preferably are molded in a continuous molding operation and reeled in continuous length. The transmission lines are then cut to length and the molded spacers are aligned with slots or grooves in the ground structure. Openings are present to allow for connectorization of the backplane assembly. The connector system can also have contacts with slots that are press fit over the conductors to make an electrical connection to the conductors of the transmission lines. In this manner, the body of the connector can be at a right angle to the backplane and designed to accept daughter cards.

The connector system may have contacts with slots that are press fitted over the conductors to make an electrical connection to the conductors of the transmission lines. The body of the connector is at right angles to the backplane and is designed to accept daughter cards. The connectors require care in design to maintain impedance control and grounding throughout the transmission line pathway. In addition, the slot in the ground plane structure requires that the ground structure must be bridged by the connector. If care is not taken in the connector design, a high impedance discontinuity spike may occur as a result of having a gap in the ground plane at the area of the slot. This is avoided by the use of a specially designed connector.

An alternative embodiment of the system uses a series of discrete links, rather than continuous transmission lines with openings in the ground plane structure. These links are interconnected by short pad areas on the printed circuit board that either have associated holes, or surface mount solder pads for module termination. Careful design of the pads and terminations minimize potential impedance discontinuities and shield interruptions. In addition, connectors for the daughter cards can be mounted either between the links or on the opposite side of the board. In this case, both conventional connectors and custom connector designs may be used, with higher performance attainable with the custom connector designs.

This approach allows for the manufacture of separate discrete component modules that are assembled on standard printed circuit board structures. This further allows the invention to be utilized by a larger number of backplane manufacturers, since each manufacturer is able to purchase components and assemble them similarly to any other backplane component. The connector design also needs not to be tightly integrated into the design. On the other hand, this approach does not preclude custom connector designs and more direct integration into the printed circuit board (PCB) structure.

The concept for manufacturing the links is relatively simple and is illustrated in FIG. 5. The transmission line conductors are cut off in discrete lengths and the ends bent at right angles to form staple like elements. The middle section of the staple is determined by the link length and the short legs by the thickness of the PCB the link is to be mounted on. The short legs of the “staple” are inserted into a hole of a thin PCB that serves as the bottom shield of the link.

The shield layer around the leads is etched away in the areas where the signal lines go through the board and the ground lines are soldered directly to the shield. The wire staples are inserted over the filament spacers that provide the appropriate spacing for the impedance matched system. The upper shield layer has additional filament spacers and is assembled on top of the transmission line conductors. The outer conductors of the link may consist of larger ground or capacitively coupled power conductors, as previously discussed. The upper shield can be a thin printed circuit board, similar to the bottom board, or alternatively is a relatively thin sheet metal cover structure. The two shields are mechanically and electrically fastened to each another. Some of the mechanical structures that are used in the module design are:

Extrusions with end caps

Plastic molded frame

Die Cast frame

Screws or rivets with spacers

A surface mounted version of the link can be similarly designed, except that the solder tails are bent, after insertion through the printed circuit board, so that they are in the same plane as the link. Alternatively, the leads can extend in a co-planar manner through spacers and formed so that they are co-planar to the link, but able to contact the printed circuit board surface.

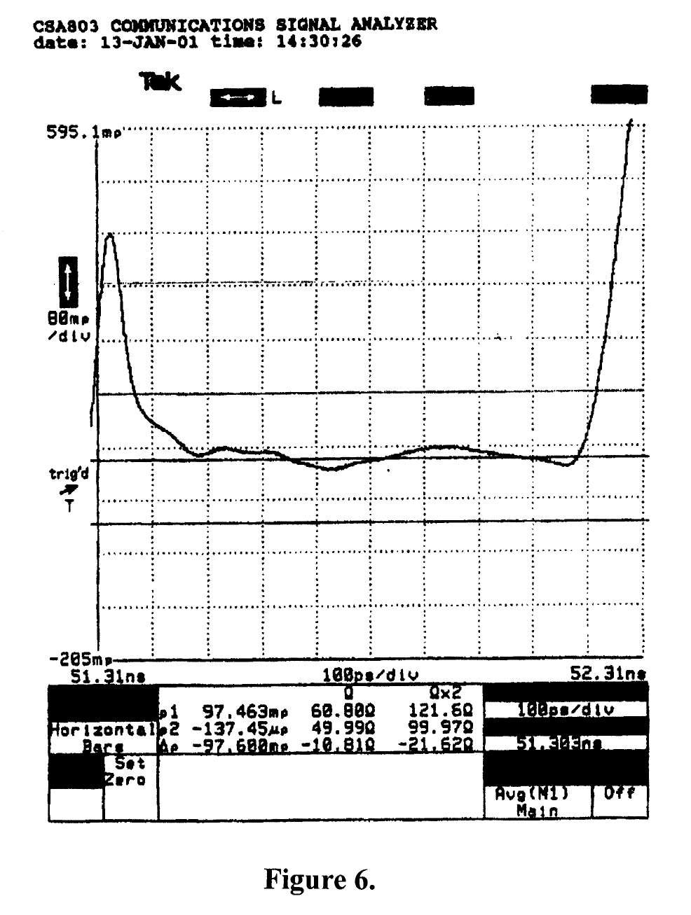

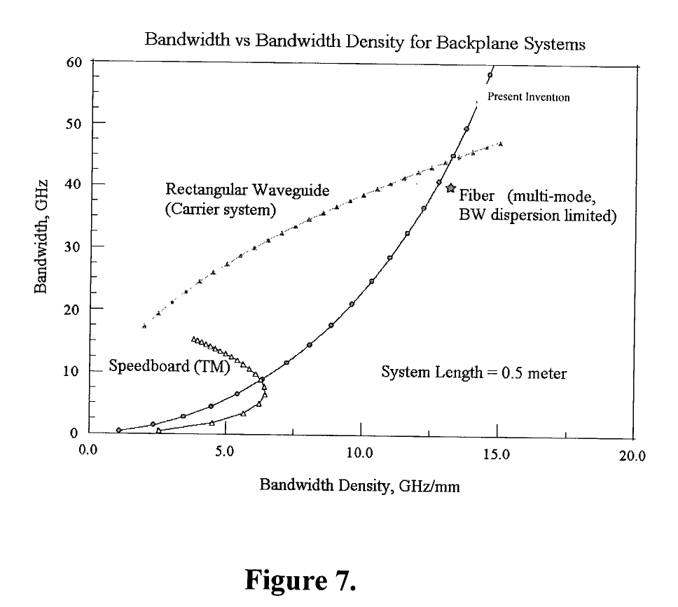

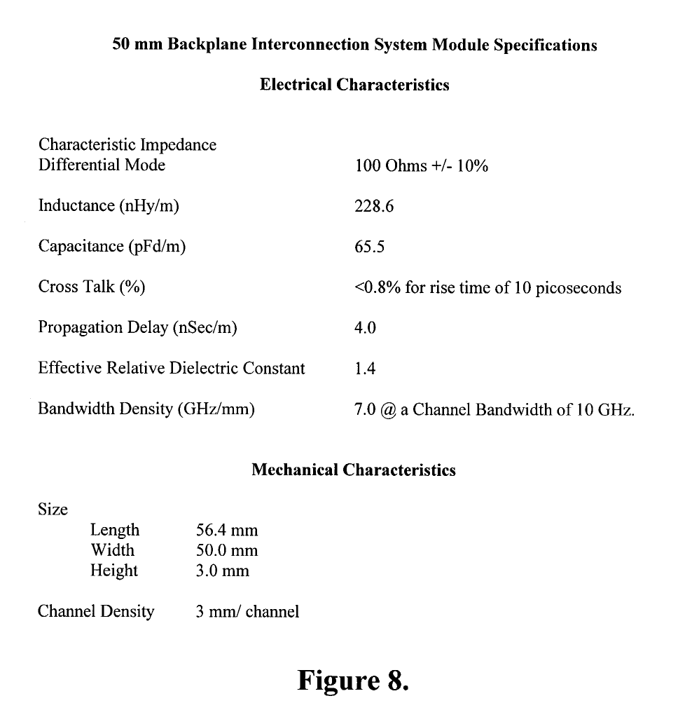

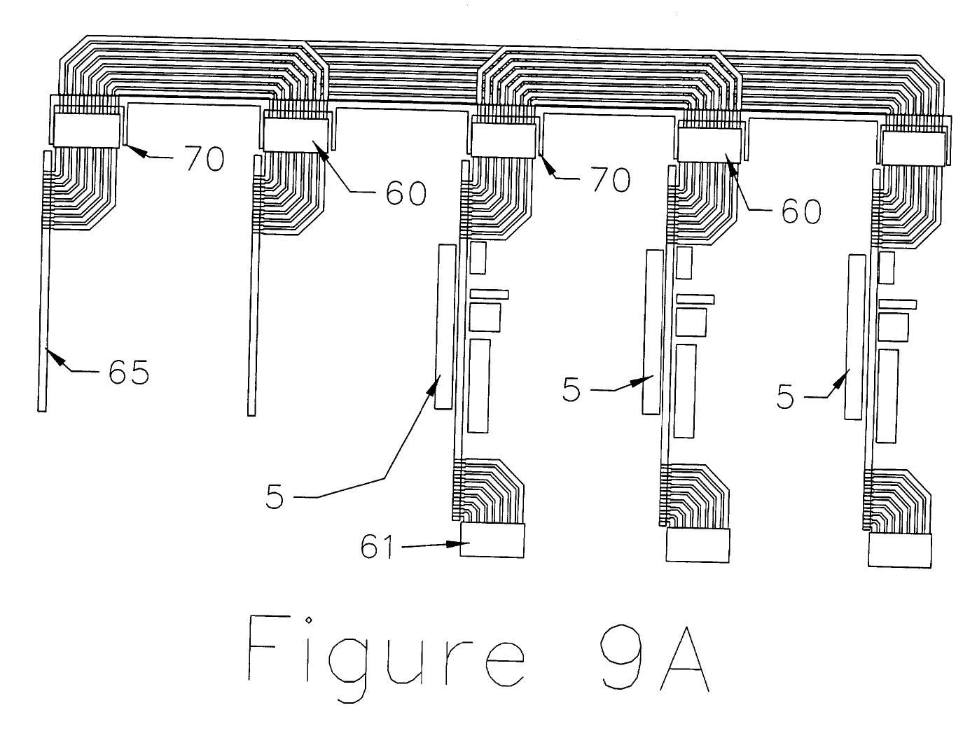

The TDR of a module, constructed according to the above principles, is shown in FIG. 6, and illustrates the relatively constant characteristic impedance achieved by these methods. The driven end of the module had some termination inductance and the far end was open circuited. The bandwidth-bandwidth density characteristics of the module system of the present invention relative to other types of backplane systems is shown in FIG. 7. The typical electrical and mechanical specifications for a module are shown in FIG. 8.

Another embodiment of the present invention uses a relatively thin sheet metal stamping into which holes or slots are stamped in the area where the leads are to protrude. A plastic molding with holes corresponding to the centers of the transmission line conductors is press-fitted through the holes in the stamping. The spacers that are used instead of the filaments are part of the molding, eliminating the need for separate parts and assembly operations. These spacers may have grooves that aid in locating the conductors laterally. The conductors can lay in the grooves of the spacers and the top cover is assembled to the base. The cover is designed to precisely clamp the conductors in place.

In the simplest design, only one ground plane is used. Although there is a slight performance penalty for this design, the reduced part count is justified by manufacturing cost reductions. The clamping area and transitions through the connector have controlled impedance throughout the structure and onto the printed circuit board transition. The printed circuit transition and impedance is controlled by careful spacing of the centerlines of the ground and signal conductors through the module and onto the printed circuit transition.

In one embodiment, the ground conductors are eliminated and the grounds terminated by means of extensions of the ground planes by means of thin metal tabs that project through the housing and are soldered into holes or pads on the printed circuit board. Any reduction in transmission line performance is offset by the significant cost reduction that results by eliminating about ⅓ of the conductors that are normally used. This embodiment is particularly useful in high volume standardized designs, where piece cost is an important issue, whereas, printed circuit board embodiments, above, are more commonly used with custom or prototype designs where tooling costs are a more important consideration.

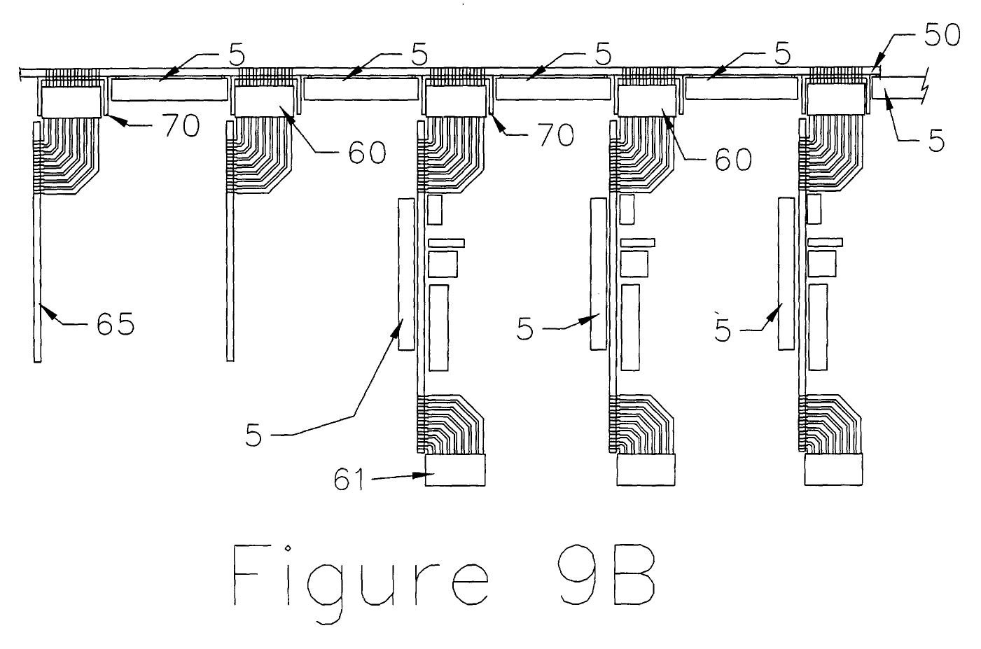

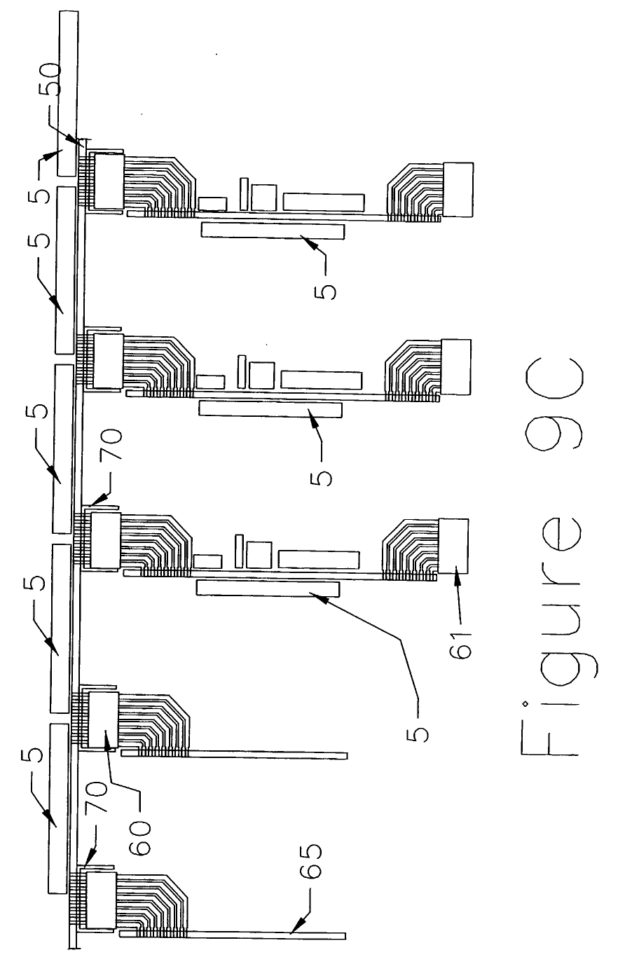

The modules are applied to the system's design in several ways. A schematic representation of a backplane system using these modules is shown in FIG. 9A, FIG. 9B and FIG. 9C. One embodiment uses the modules between backplane connectors. In this case the modules and the backplane connectors are on the same surface of the printed circuit boards (FIG. 9B). Another embodiment places the modules on the opposite side of the printed circuit boards (FIG. 9C). There are advantages and disadvantage to both configurations, depending on the specific application. The modules can further be used on certain types of daughter cards, where the architecture requires relatively long lengths (>2″).

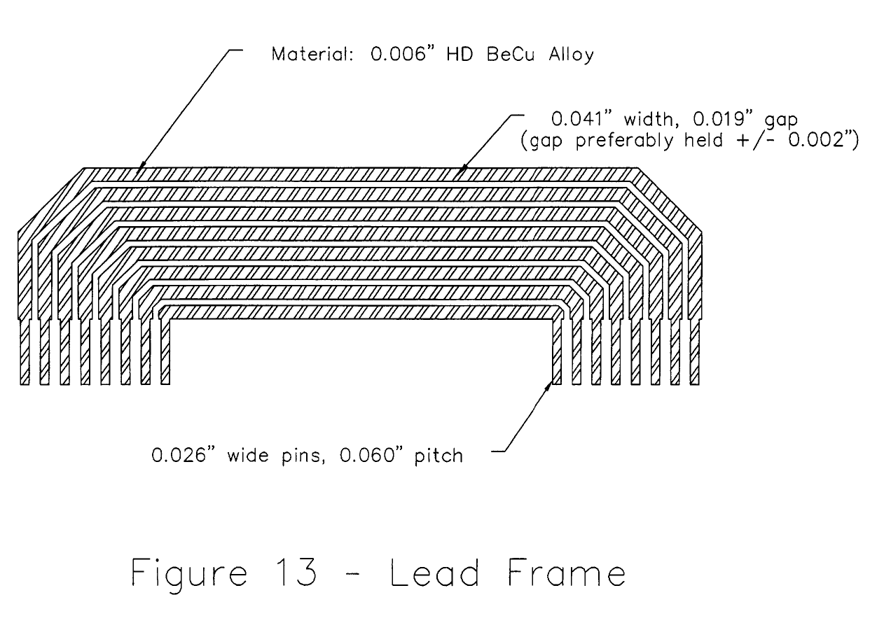

Another embodiment uses lead frames instead of the modules (FIG. 9A). Lead frames may be stamped from a conductive material. An example of one embodiment for lead frames is illustrated in FIG. 13.

The most difficult part of the design of this type of system is the transitional elements between the links and the connectors, since the design and manufacture of the module transmission line structure is relatively straight forward and uses well known design principles. Although recommendations can be made in this area, it will ultimately be the responsibility of the manufacturer for each particular application. The disadvantage of this approach is that the performance of the system is at the discretion the system designer. On the other hand, this approach frees each manufacturer to use the transition and connectorization scheme that gives their product the greatest competitive advantage, and the link module becomes just another component in the system, and the complete system design is not preordained. This should make the approach more attractive to larger users. However, smaller user, with less engineering resources can use preconfigured systems to reduce their engineering costs and reduce design cycle times without over dependence on outside engineering resources.

It appears that the highest density that is practical and still results in a significant performance increase is a module with individual conductors on 1 mm centers giving a channel density of 3 mm. This may be limiting for many applications. In order to achieve higher densities, multi-layer designs with higher circuit density can be designed and constructed. Theoretically, any number of layers can be constructed, but the practical limit is probably 4 layers. Each layer has appropriate grounds. In a 2-layer system, two heights of “staples” are used for a lower and upper transmission layer composed of wires or stamped lead frames. Any number of layers are possible, although 8 layers should be adequate for most applications. Increasing the density further raises the heights of the module.

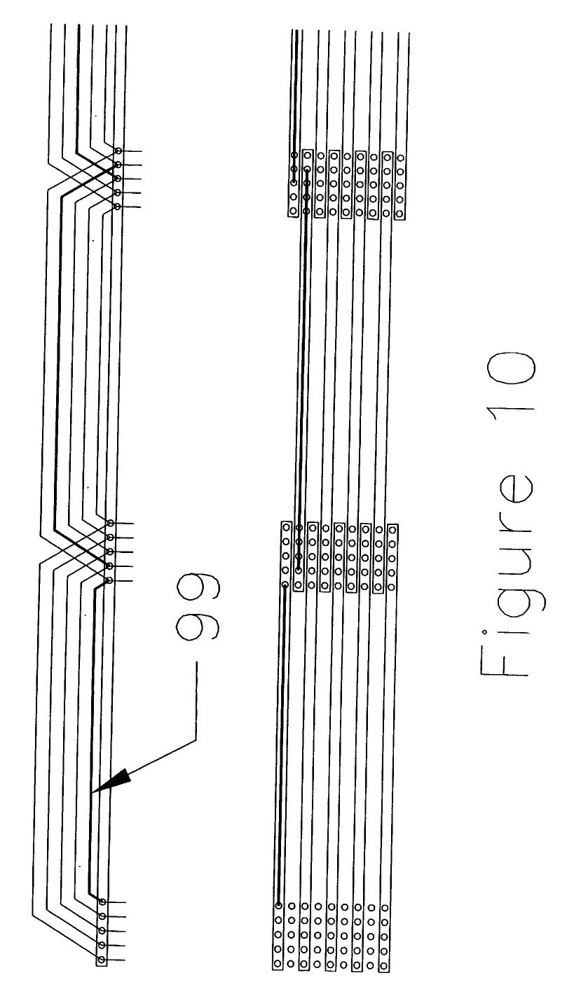

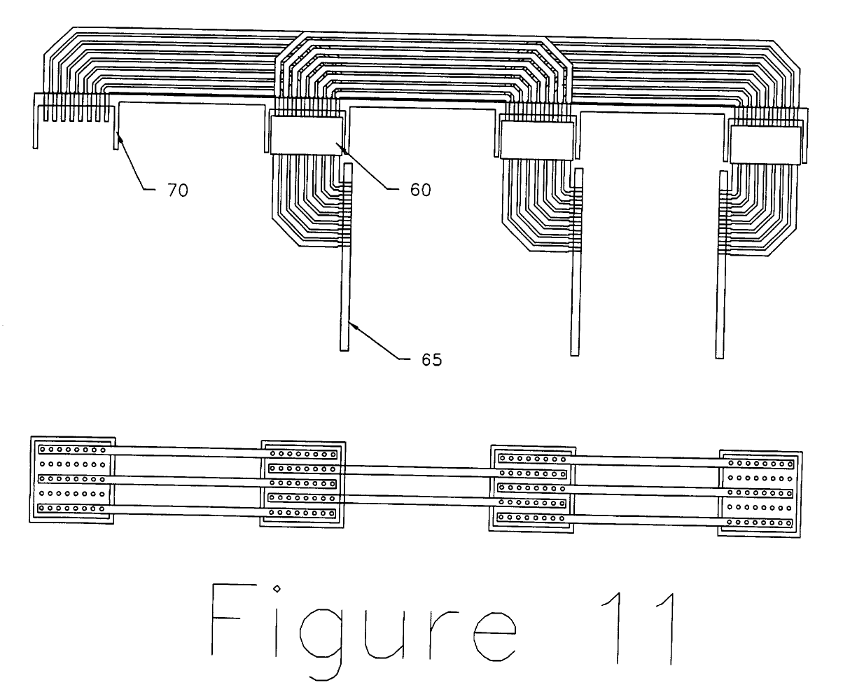

One preferred method of arranging the conductors relative to each other is to stagger the centers of the conductors so that the net conductor pitch of the two rows is half the pitch of the conductors on each layer. This arrangement of the layers is shown schematically in FIG. 10. For example, if the pitch on an individual layer is 0.050″ the effective pitch of two layers is 0.025″. The conductors exit the module through a hole pattern of 0.050″ with staggered rows to maximize the space between the holes so that the trace width can be optimized.

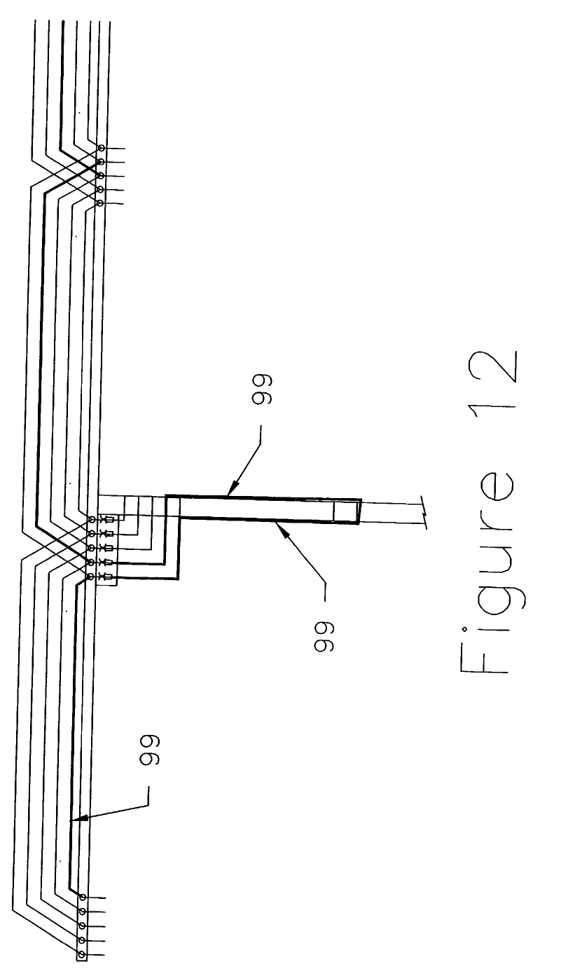

Although a number of connectors can be used with this type of system, ideally, the connector system has the same pitch as the transmission line system with the same number of rows as layers in the module. An example of integration of the connectors into the backplane interconnection system is shown in FIG. 11. For example, a connector for a module with two layers on 0.050″ pitch is a two row connector on 0.050″ spacing. This minimizes 1) the variation in line lengths that can induce jitter and 2) changes in line geometry, which results in impedance discontinuities. The connector preferably is a surface mount leaded device to minimize impedance discontinuities. However, press fit connectors can be used if care is taken in via design and stubs are minimized.

The routing of the transmission line path through the daughter card is shown in FIG. 12. Such a routing minimizes the effects of circuit board via “stubs” that can seriously limit the system bandwidth and performance.

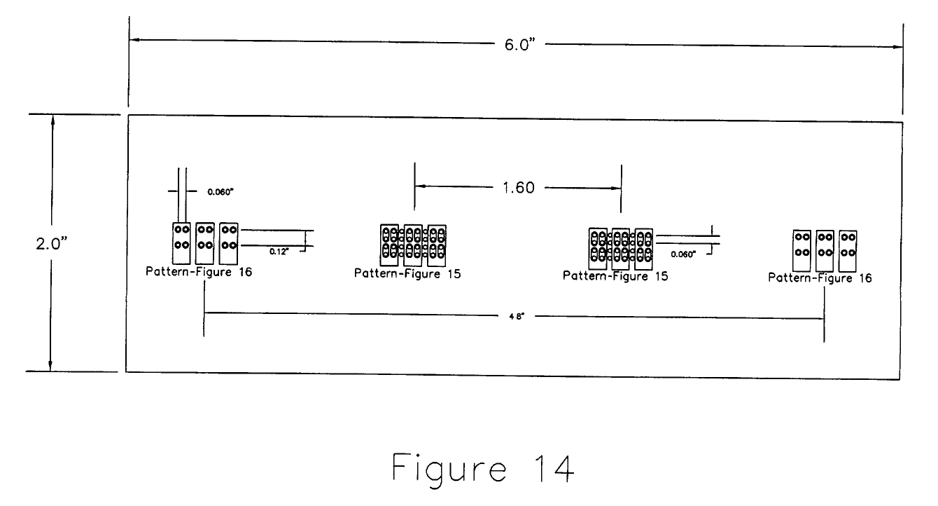

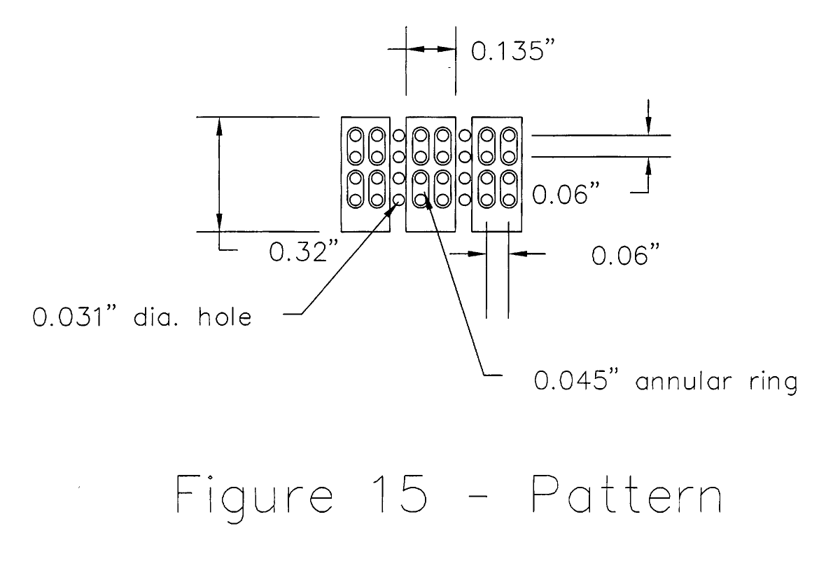

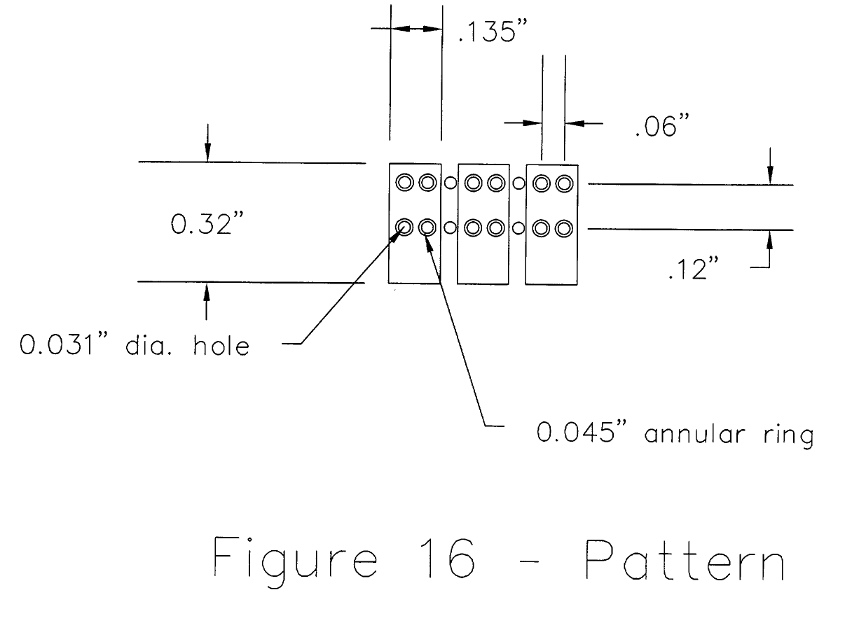

An example of a stamped lead frame structure for a multiplayer Backplane Interconnection System test board is shown in FIG. 13. The test board lay out is shown in FIG. 14, with details of the circuit traces for patterns A and B shown in FIGS. 15 and 16 respectively.

Module widths are preferably limited to 2 inches (50 mm) since large widths may cause difficulties in manufacturing the parts to sufficiently tight tolerances. Also, the reliability of standard surface mount techniques tends to drop off as 2 inches is approached. From twelve, (0.050″) pitch, to 16, (1 mm pitch), differential channels per module layer appears to be the easily achievable.

### CITATIONS INCORPORATED BY REFERENCE

1. Ramo, S., Whinnery, J. R., and Van Duzer, T., Fields and Waves in Communication Electronics, John Wiley & Sons Inc., New York, N.Y. pp 330-337, (1965).

2. Elco, R. A., Metral High Bandwidth—A Differential Pair Connector for Applications up to 6 GHz, IMAPS 99 Workshop, January (1999).

What is claimed is:

1. A high speed backplane interconnection system comprising: a plurality of conductor matched impedance transmission line elements; and an air dielectric surrounding the plurality of transmission line elements.

2. The interconnection system of claim 1, further comprising: a ground plate disposed a predetermined distance from the transmission line elements wherein the predetermined distance is reflective of a characteristic impedance of the system.

3. The interconnection system of claim 1, further comprising: a base plate; and a plurality of spacers positioned on said base plate for securing the transmission line elements a predetermined distance from said base plate.

4. The interconnection system of claim 3, wherein the spacers are formed from a nonconductive material.

5. The interconnection system of claim 1, further comprising: a housing surrounding the transmission line elements.

6. The interconnection system of claim 5, wherein the housing comprises: a cover; and a base adapted to securely receive the cover.

7. The interconnection system of claim 6, wherein the cover and the base are formed from a non-conductive material.

8. The interconnection system of claim 1, further comprising: a plurality of signal tabs, each signal tab connected to an end of each transmission line and also adapted to be connected to an electrical system such that when the signal tab is connected to the electrical system an electrical connection is established between the transmission line and the electrical system.

9. The interconnection system of claim 2, further comprising: at least one ground tab connected to the ground plate for connecting the ground plate to a ground.

10. The interconnection system of claim 1, wherein the transmission line elements have a round cross-section.

11. An electrical system comprising: a backplane; and a high speed interconnection system disposed on said backplane, the interconnection system comprising: a plurality of conductor matched impedance transmission line elements; and an air dielectric surrounding the plurality of transmission line elements.

12. The interconnection system of claim 11, further comprising high speed interconnection modules comprising: a base plate; and a plurality of spacers positioned on said base plate for securing the transmission line elements a predetermined distance from said base plate.

13. The interconnection system of claim 12, wherein the spacers are formed from a nonconductive material.

14. The interconnection system of claim 12, wherein the spacers are molded into the base plate.

15. The interconnection system of claim 12, wherein the spacers are staple lengths of monofilament non-conductive material.

16. The interconnection system of claim 12, further comprising a ground plane of conductive material.

17. The interconnection system of claim 12 further comprising a ground plane, wherein the modules comprise 24 transmission line elements of 28 AWG conductors spanning a distance of from 40 to 50 mm at a predetermined distance of 0.008 to 0.012 inches from the ground plane.

18. The interconnection system of claim 17 wherein adjacent transmission line elements are secured on a 0.050″ pitch.

19. The interconnection system of claim 17 wherein adjacent transmission line elements are secured on a 1 mm pitch.

20. An electrical system comprising: a backplane; and a high speed interconnection system disposed on said backplane, the interconnection system comprising: a plurality of conductor matched impedance transmission line elements; an air dielectric surrounding the plurality of transmission line elements; wherein the plurality of conductor matched impedance transmission line elements are formed into a lead frame.

21. The electrical system of claim 20 further comprising lead frame line elements from 0.039″ to 0.043″ in width wherein lead frame line elements are positioned a distance of from 0.017″ to 0.021″ between adjacent lead frame line elements.
